(19) United States
(12) Patent Application Publication
(10) Pub. No.: US 2008/0159706 A1
(43) Pub. Date: Jul. 3, 2008

(54) Optical Fiber Comprising a Strippable Coating and Method of Stripping One Such Fiber

(76) Inventors: Sebastien Andre, Pignan (FR); Xavier Andrieu, Bretigny Sur Orge (FR); Gilles Melin, Orsay (FR)

Correspondence Address: SUGHRUE MION, PLLC, 2100 PENNSYLVANIA AVENUE, N.W., SUITE 800, WASHINGTON, DC, 20037, US

(21) Appl. No.: 10/591,676

(22) PCT Filed: Feb. 28, 2005
(86) PCT No.: PCT/FR2005/000471

§ 371 Date: Dec. 14, 2006

(30) Foreign Application Priority Data
Mar. 4, 2004 (FR) 0450441

(51) Int. Cl. G02B 6/00; B23P 17/00

(52) U.S. Cl. 385/144; 29/426.1

(57) ABSTRACT

The invention relates to an optical fibre having a coating comprising at least two layers (4, 5). The first layer 91) comprises the reaction product of a first composition containing at least one polyether urethane (meth) acrylate oligomer, a first (meth)acrylate monomer and a second (meth) acrylate monomer. The second layer (2) comprises the reaction product of a second composition containing at lest one first polyether urethane (meth)acrylate oligomer, a second epoxy (meth) acrylate oligomer, a first (meth)acrylate monomer and a second (meth)acrylate monomer. The invention also relates to an optical fibre stripping method comprising a step (a) consisting in supplying the inventive optical fibre (1) and the stripping means, a step (b) consisting in bringing the optical fibre (1) and the stripping means into contact with each other, and a step (c) consisting in moving the fibre and the stripping means in relation to one another.

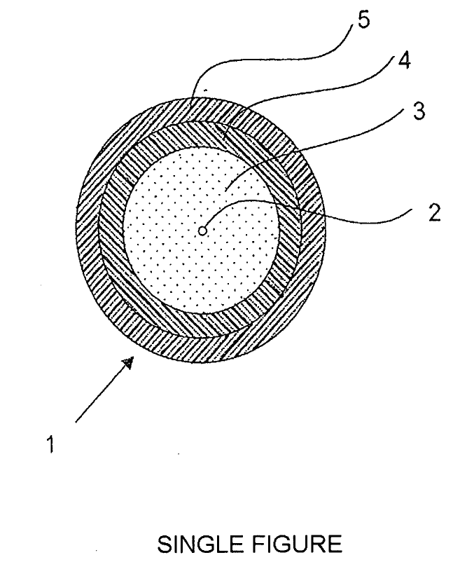

The invention relates to a novel optical fiber having an easily strippable coating and to a novel method of stripping such a fiber.

Optical fibers and methods of manufacturing such fibers are known. The process for manufacturing an optical fiber conventionally comprises the manufacture of a preform, followed by the drawing of this preform into a fiber. The fiberizing operation, that is to say the conversion of the preform into fiber, takes place for example by contactless drawing, by softening the end of the preform in an induction furnace filled with an inert gas. The diameter of the fiber is measured at the outlet of the furnace in order to slave the draw speed in order to keep the diameter of the fiber constant. The fiberizing speed may exceed 15 m/s.

Typically, during the fiberizing operation, downstream of the outlet of the furnace, the silica cladding is coated with a primary coating, which is in general a resin that is cured by ultraviolet (UV) radiation. This coating serves especially to damp the effects of external stresses, to prevent the propagation of cracks and, possibly, to absorb the cladding modes thanks to a higher index of the coating than the silica cladding. Typically, resins of the epoxy acrylate type are used. Usually, after application of the primary coating, the fiber is then coated with a more rigid secondary coating.

The core of the optical fiber may be doped with various chemical elements, so as to meet various applications. In some applications, it is necessary to carry out a treatment on the fiber, for example for photowriting a Bragg grating. A Bragg grating possesses a periodic structure, capable of diffracting a signal and of extracting therefrom a restricted range of wavelengths, said range being determined by the period of the structure. Bragg grating filters have in turn a variety of applications in optics, such as demultiplexers, dispersion compensators and gain equalization filters. To photowrite a Bragg grating, the fiber must be stripped (by layer peeling), etched and then re-clad. It may also prove necessary to strip the fiber at one end, for example for a splice or a connection. The stripping of the fib generally comprises the removal of a coating (made of a polymer) from the optical fiber.

For example, FR-2 823 572 teaches a method of stripping an optical fiber.

Various UV-curable coating compositions for optical fibers are also known.

For example, the subject of WO-02/096180 is a UV-curable coating composition for a fiber, with the aim of improving the thermal and hydrolitic stability and also of improving the mechanical properties of the fiber. The composition may comprise a compound having a saturated aliphatic backbone carrying an epoxy group at one end and a reactive functional group at the other end (especially a hydroxyl, acrylate, vinyl ether, epoxy, alcohol or isocyanate group). The composition may further comprise a mixture of acrylate or vinyl ether monomers carrying an acrylate or vinyl ether group, and also a monomer carrying at least two acrylate or vinyl ether groups.

The subject of EP-1 247 843 is a photocurable (UV-curable) composition for a primary coating layer on the glass surface, especially for an optical waveguide, with the aim of improving the cure rate and the rate of adhesion to the glass (prevention of delamination). The photocurable composition comprises an acrylate oligomer, preferably a difunctional urethane acrylate having a polyether backbone of formula: R1-(I1-P)ₙ-I2-R2, where R is a curable functional group (an acrylate), I is an isocyanate and P is a polyether. The composition may further comprise a vinyl (meth)acrylate compound, representing between 2 and 25% of the weight of the composition, and, optionally, a reactive diluent comprising one or more acrylate compounds. The composition also includes a photoinitiator and, optionally, other additives such as an adhesion promoter, a thermal observation stabilizer and/or a photosensitizer.

The subject of WO-99/31161 is a UV-curable liquid composition for a secondary coating layer for fibers, with the aim of reducing a friction coefficient and of improving mechanical properties of the fibers. The composition may comprise an aliphatic urethane acrylate oligomer having a polyether or polyester backbone. The composition may also comprise an isobornyl (meth)acrylate, an alkanediol di(meth)acrylate, alkoxylated derivatives or mixtures thereof, and also a photoinitiator. Optionally, the composition includes an antioxidant and an antifoaming agent.

The subject of EP-0 587 486 is a polymer resin composition formed from a blend for a coating of the urethane acrylate type intended for fiber-optic ribbon cable. The aim of the composition is to improve the slip quality of fiber-optic ribbon cables. The composition may especially comprise an epoxy acrylate or urethane acrylate polymer, and also a copolymer carrying polysiloxane chains and representing between 0.5 and 20% of the total weight of the composition.

The subject of U.S. Pat. No. 5,418,016 is also UV-curable compositions. These compositions are applicable to coatings, which may be colored, to printing inks, to adhesives, etc. In particular, the aim of these compositions is a reduction in viscosity for processing them. They may comprise an oligomer of the following types: epoxy acrylate, polyester acrylate, polyurethane acrylate, vinyl ether, etc., and blends thereof. These compositions may further include an N-vinylformamide monomer and, optionally, a monofunctional or polyfunctional vinyl or acrylic monomer. They also include a photoinitiator of the benzophenone or benzoic ether type.

However, the fiber coatings obtained from the photocurable compositions described above are not optimized for the purpose of stripping the fiber. Furthermore, some of these coatings change over time in such a way that it is no longer possible to strip the fiber after a few months. Other such coatings are not suitable for stripping with an organic solvent or they are stripped with the use of highly corrosive strong acids (sulfuric acid, hydrochloric acid, nitric acid, etc.), which may damage the silica cladding.

There is therefore a need for a novel optical fiber having a strippable coating and for a novel method of stripping such a fiber, which allow improved stripping of the fiber.

Thus, the invention proposes an optical fiber having a coating comprising at least two layers, in which the first layer comprises the reaction product of a first composition comprising at least: a polyether urethane (meth)acrylate oligomer; and first and second (meth)acrylate monomers; and in which the second layer comprises the reaction product of a second composition comprising at least: a polyether urethane (meth)acrylate first oligomer; an epoxy (meth)acrylate second oligomer; and first and second (meth)acrylate monomers.

In preferred embodiments, the invention comprises one or more of the following features:
at least one of the oligomers comprises an aliphatic polyether urethane diacrylate;
one of the oligomers comprises an aromatic polyether urethane diacrylate;
the second oligomer of the second layer of the coating comprises a bisphenol A epoxy (meth)acrylate and the second monomer of the first layer is an isobornyl (meth)acrylate;
the first monomer of the second layer is a trimethylolpropane triacrylate;
the second monomer of the second layer is a polyethylene glycol diacrylate;
the second composition further includes at least one initiator and at least one synergist, the initiator being a benzophenone and the synergist being a copolymerizable amine (meth)acrylate;
the oligomer of the first layer represents between 45 and 85% of the total weight of the composition of the first layer and its molar mass is between 2500 and 8000 g/mol;
the first oligomer of the second layer represents between 15 and 45% of the total weight of the composition of the second layer and its molar mass is between 1000 and 10 000 g/mol;
the second oligomer of the second layer represents between 15 and 45% of the total weight of the composition of the second layer and its molar mass is between 100 and 3000 g/mol;
in each of the layers, the first monomer represents between 5 and 60% of the total weight of the composition; and
in each of the layers, the first monomer represents between 5 and 15% of the total weight of the composition.

The invention also relates to a method of stripping an optical fiber comprising the following steps: (a) the optical fiber according to the invention and stripping means are provided; and (b) the optical fiber is brought into contact with the stripping means.

According to a variant, the stripping means provided at step (a) comprise an etchant.

According to another variant, the etchant provided at step (a) comprises a dichloromethane/methanol mixture.

According to yet another variant, the method according to the invention further includes step (c) of rinsing the fiber with an organic solvent and step (d) of drying the fiber.

According to another variant, the method further includes a step (c) of causing relative movement between the fiber and the stripping means.

According to another variant, the stripping means provided at step (a) form an opening that can be adjusted substantially to the diameter of the fiber less twice the thickness of the coating of the fiber, and the contacting at step (b) also includes adjusting said opening to said reduced diameter.

Other features and advantages of the invention will become apparent on reading the following description of the embodiments of the invention, given by way of example and with reference to the single appended FIGURE, which shows a diagram of an optical fiber according to the invention, seen in cross section.

The term “polyether” is understood to mean a polymer in which the structural repeat unit in the polymer chain comprises at least one functional group of the ether type.

The term “initiator” is understood to mean a chemical substance that initiates a chemical reaction, in particular a polymerization.

The term “cure” is understood to mean the formation of multiple and various intermolecular bonds, for example of the following types: covalent, ionic, hydrogen bond, Van der Waals, etc., between polymer chains.

The term “oligomer” is understood to mean a product consisting of a concatenation of a small number of repeat units, which themselves consist of molecules comprising a small number of one or more species of atoms or groups of atoms (constitutional units) linked together. This term is also understood to mean a product whose physical properties vary according to the addition or elimination of only one or a small number of constitutional units of its molecules.

The term “synergist” is understood to mean a product which, when combined with other products of a reactive mixture, increases their effects in the mixture reaction.

The invention proposes an optical fiber having a coating comprising at least two layers. The first layer comprises the reaction product of a first composition comprising at least one polyether urethane (meth)acrylate oligomer and first and second (meth)acrylate monomers. The second layer comprises the reaction product of a second composition comprising at least one polyether urethane (meth)acrylate first oligomer, an epoxy (meth)acrylate second oligomer, and first and second (meth)acrylate monomers. According to one particular embodiment, the invention also proposes a method of stripping an optical fiber, comprising the following steps (a): the optical fiber according to the invention and an etchant are provided; and (b) the optical fiber is brought into contact with the etchant. Such a fiber and such a method make it possible to improve stripping of the fiber. They also make it possible to strip an optical fiber with a nontoxic solvent and for the stripping to be carried out several months after the coating has been deposited on the fiber.

The single FIGURE shows a diagram of an optical fiber according to the invention, seen in cross section (with no scale). More precisely, the FIGURE shows a fiber core 2, at the center of the coated fiber 1, surrounded by a silica cladding 3. The cladding 3 is coated with an optical fiber coating. The coating of the optical fiber 1 according to the invention itself comprises at least two layers 4 and 5. For example, it comprises a first layer 4 and a second layer 5, also called primary layer and secondary layer, or else primary coating and secondary coating.

The first layer will now be described in a general manner.

The first layer comprises the product resulting from the reaction of a first composition. The first composition comprises, according to the invention, at least one polyether urethane (meth)acrylate oligomer and first and second (meth)acrylate monomers. Other components of this first composition will be described later. Typically, the reaction is a UV curing reaction.

The polyether urethane (meth)acrylate oligomer allows the first layer to adhere to the fiber. Furthermore, tests have shown that such an oligomer is capable of favoring the swelling of the layer under the action of an etchant such as an organic solvent. The first (meth)acrylate monomer is chosen in such a way as to allow the reactivity and the flexibility of the mixture to be controlled. The second (meth)acrylate monomer is chosen so as to increase the flexibility of the mixture of the first composition, to contribute to the adhesion of the first layer to the fiber and so as to control the level of the viscosity of the mixture. The oligomer and the monomers are also chosen according to their compatibility.

The second layer will now be described in a general manner.

The second layer of the coating comprises the product resulting from the reaction of a second composition comprising at least a polyether urethane (meth)acrylate first oligomer, an epoxy (meth)acrylate second oligomer and first and second (meth)acrylate monomers.

The polyether urethane (meth)acrylate first oligomer promotes adhesion to the first layer of the coating. The epoxy (meth)acrylate second oligomer allows the hardness of the layer to be controlled and also increases the control of the reactivity of the second composition. Here again, the (meth)acrylate monomers are chosen so as to allow control of the reactivity, of the viscosity of the mixture and greater flexibility. These components are also chosen according to their compatibility.

Such a coating has advantages. For example, it is suitable for being stripped (or peeled), and to be so even several months after the optical fiber has been coated. It is also capable of undergoing a treatment for facilitating the stripping with an organic solvent.

It should be understood that the coating according to the invention is optimized in particular with a view to its subsequent stripping, and in particular to its chemical stripping. A major parameter of the composition of the coating according to the invention is therefore the subsequent strippability of the coating (that is to say its ability to be stripped), unlike line fibers or transmission fibers for which the major parameter is a polymerization rate.

Oligomers that can be used in the composition of the coating of the optical fiber according to the invention will now be described in greater detail.

Polyether urethane (meth)acrylate oligomers have proved, by experiment, to be more flexible than polyester urethane (meth)acrylate oligomers. Such oligomers also offer other advantages. For example, they typically make it possible to obtain a viscosity slightly lower than that which can be obtained with polyester urethane acrylate oligomers, for the same functionality and approximately the same molecular weight.

In one embodiment, at least one of the oligomers is an aliphatic polyether urethane diacrylate oligomer, and preferably the oligomer of the first layer and the first oligomer of the second layer are both aliphatic polyether urethane diacrylate oligomers. Apart from the good adhesion that they provide, one advantage associated with the use of such oligomers is that they have excellent anti-yellowing properties.

It is also possible to use, in the composition of the first layer, a polyether urethane diacrylate oligomer whose molar mass is between 2500 and 8000 g/mol, preferably between 3500 and 6500 g/mol and even more preferably between 4500 and 5800 g/mol. Depending on the fiber production constraints (for example the fiberizing speed) that are imposed, this oligomer represents between 45 and 85% of the total weight of the composition of the first layer.

In the composition of the second layer, it is possible to use a first oligomer of molar mass between 1000 and 10 000 g/mol and preferably between 4500 and 5800 g/mol.

As second oligomer of the second layer, an epoxy (meth)acrylate oligomer of molar mass between 100 and 3000 g/mol, and preferably between 700 and 1300 g/mol, may be used.

The first and second oligomers of the second layer typically represent between 15 and 45% of the total weight of the composition of the second layer.

In one embodiment, a polyether urethane diacrylate first oligomer is used, for example for the second layer, which oligomer offers a good compromise between stiffness and swelling in organic solvents.

The second oligomer of the second layer of the coating may comprise a bisphenol A epoxy (meth)acrylate, which proves to be particularly well suited to controlling the hardness of the layer, in combination with other components mentioned above.

Monomers that can be used in the composition of the coating of the optical fiber according to the invention will now be described in greater detail.

For example, it is possible to use, for the first layer, a first 2-phenoxyethyl (meth)acrylate monomer. Apart from its diluent, flexibility and reactivity qualities, this monomer promotes adhesion, owing to its low shrinkage.

It is also possible to combine this first monomer with an isobornyl (meth)acrylate second monomer which, apart from its adhesion and viscosity properties, improves mechanical strength of the layer.

The first monomer of the second layer may be a trimethylolpropane triacrylate or TMPTA. This acrylic monomer is trifunctional, and therefore highly reactive. It provides the right balance between good mechanical strength and solvent resistance. Its chemical resistance properties make it possible to balance the propensity of the second layer to be stripped using a solvent, which propensity is partly conferred by the first oligomer.

The second monomer of the second layer may be a polyethylene glycol diacrylate which, combined with the above monomer, allows extensive control of the reactivity and the viscosity of the second layer.

Typically, the first monomer represents between 5 and 60% of the total weight of the composition of each of the first and second layers, the second monomer representing between 5 and 15% of the total weight of the composition.

Other components that can be used in the composition of the coating of the optical fiber according to the invention, such as initiators and more particularly photoinitiators, will now be described.

The composition of the first layer may further include an initiator, such as a 1-hydroxycyclohexyl phenyl ketone so as to improve the reactivity of the first composition.

Likewise, the composition of the second layer may further include at least one initiator and at least one synergist, so as to improve the reactivity thereof.

An initiator for the second layer may be a benzophenone and the synergist may be a copolymerizable amine (meth)acrylate. As a result of experiments, it appears that this combination, combined with the above components of the composition of the second layer, makes it possible for the surface polymerization to be substantially improved, and thus to obtain better surface hardness. The protection conferred on the optical fiber according to the invention is thus improved, without thereby impairing the strippability of the fiber.

It should also be noted that it is possible to envisage the use of a benzoic ether as initiator of the second layer.

The second composition may further include a second initiator, for example 2,2-dimethoxy-1,2-diphenylethanone, which increases the reactivity of the second composition even more, and is compatible with the above components.

The invention also relates to a method of stripping an optical fiber. This method comprises a first step (a) of supplying the optical fiber according to the invention and stripping means (for example an etchant, preferably a nontoxic etchant). The method further includes a second step (b) of contacting the optical fiber with the stripping means.

For example, the fiber may be immersed in an etchant bath.

As a variant, the etchant may be sprayed onto the fiber, as is known in the art.

Preferably, the etchant provided at step (a) of the method according to the invention comprises a dichloromethane/methanol mixture. The compositions forming the basis of the coating of the fiber according to the invention are particularly suitable for the use of such an etchant. In particular, there is improved swelling of the coating of the fiber subjected to such a mixture, especially owing to the use of oligomers of the polyether urethane (meth)acrylate type in its composition.

It should be mentioned that the mass distribution of the components, in each of the first and second compositions, may be optimized using the Hansen methods (C. M. Hansen, “Hansen Solubility Parameter, A User's Handbook”, CRC Press, 1999) and for an etchant of given composition, for example a dichloromethane/methanol mixture.

Furthermore, acceptable stripping of a fiber according to the invention using such a mixture remains possible several months after the fiber has been coated.

The method according to the invention may further include a step (c) of rinsing the fiber with an organic solvent and step (d) of drying the fiber.

The results obtained after implementing the method according to the invention show, in a cross section of the fiber, an eccentricity of substantially between 2 and 4 microns. The resulting thickness of the fiber obtained complies with the criteria usually recommended in the art and substantially no yellowing effects are observed, even after nine months of observation. Such a yellowing effect is generally characteristic of premature aging of the coating, resulting in mechanical embrittlement. Moreover, substantially no defects visible to the naked eye are observed. In addition, the cladding ridges obtained are satisfactory, especially in that they substantially represent no defect greater in size than 1 mm. For example, a bevel-shaped ridge extends over less than 0.75 mm along the longitudinal direction of the fiber treated according to the method of the invention. Again for example, a bead-shaped ridge extends over less than 1 mm along the longitudinal direction of the treated fiber and over less than 0.4 mm along a transverse direction.

### EXAMPLES

The tables below provide examples of compositions (for the first and second layers) that can be used for the purpose of producing a fiber according to the invention.

TABLE 1
Example of a composition for the first layer before reaction

| | | Content of the layer |
|---|---|---|
| | | as % of the total |
| | | weight of the |
| Composition of the first layer | | composition |
| Oligomer | aliphatic polyether urethane | 45-85% |
| | diacrylate | |
| Monomers | 2-phenoxyethyl (meth)acrylate | 5-60% |
| | isobornyl (meth)acrylate | 5-15% |
| Photo- | 1-hydroxycyclohexyl phenyl ketone | 1-5% |
| initiator | | |

TABLE 2
Example of a composition of the second layer before reaction

| | | Content of the layer |
|---|---|---|
| | | as % of the total |
| | | weight of the |
| Composition of the second layer | | composition |
| Oligomers | aliphatic polyether urethane | 15-45% |
| | diacrylate | |
| | bisphenol A epoxy (meth)acrylate | 15-45% |
| Monomers | polyethylene glycol diacrylate | 5-60% |
| | trimethylolpropane triacrylate | 5-15% |
| Photo- | benzophenone | 0.2-4% |
| initiators | | |
| | 2,2-dimethoxy-1,2-diphenylethanone | 0.1-2% |
| Synergist | acrylated synergist | 1-5% |

The method of stripping the optical fiber according to the invention may, in one embodiment, involve mechanical stripping means.

The mechanical stripping method further includes a step (c) of causing relative movement between the fiber and the stripping means. The method therefore makes it possible to strip the optical fiber in the manner of stripping pliers. The edges of the opening may, where appropriate, apply a slight axial force to the fiber, calibrated so as not to damage the optical fiber.

In particular, the stripping means provided in step (a) of the method form an opening that can be adjusted substantially to the diameter of the fiber, excluding the coating, that is to say calibrated to the diameter of the cladding of the fiber. The contacting in step (b) may then include the adjustment of said opening to the diameter of the cladding.

1. Optical fiber having a coating comprising at least two layers, in which a first layer comprises the reaction product of a first composition comprising at least:
a polyether urethane (meth)acrylate oligomer; and
first and a second (meth)acrylate monomers; and
in which a second layer comprises the reaction product of a second composition comprising at least:
a polyether urethane (meth)acrylate first oligomer;
an epoxy (meth)acrylate second oligomer; and
first and second (meth)acrylate monomers.

2. Optical fiber according to claim 1, in which at least one of the oligomers comprises an aliphatic polyether urethane diacrylate.

3. Optical fiber according to claim 1, in which one of the oligomers comprises an aromatic polyether urethane diacrylate.

4. Optical fiber according to claim 1, in which the second oligomer of the second layer of the coating comprises a bisphenol A epoxy (meth)acrylate.

5. Optical fiber according to claim 1, in which the second monomer of the first layer is an isobornyl (meth)acrylate.

6. Optical fiber according to claim 1, in which the first monomer of the second layer is a trimethylolpropane triacrylate.

7. Optical fiber according to claim 1, in which the second monomer of the second layer is a polyethylene glycol diacrylate.

8. Optical fiber according to claim 1, in which the second composition further includes at least one initiator and at least one synergist, the initiator being a benzophenone and the synergist being a copolymerizable amine (meth)acrylate.

9. Optical fiber according to claim 1, in which the oligomer of the first layer represents between 45 and 85% of the total weight of the composition of the first layer and its molar mass is between 2500 and 8000 g/mol.

10. Optical fiber according to claim 1, in which the first oligomer of the second layer represents between 15 and 45% of the total weight of the composition of the second layer and its molar mass is between 1000 and 10 000 g/mol.

11. Optical fiber according to claim 1, in which the second oligomer of the second layer represents between 15 and 45% of the total weight of the composition of the second layer and its molar mass is between 100 and 3000 g/mol.

12. Optical fiber according to claim 1, in which, in each of the layers, the first monomer represents between 5 and 60% of the total weight of the composition.

13. Optical fiber according to claim 1, in which, in each of the layers, the first monomer represents between 5 and 15% of the total weight of the composition.

14. Method of stripping an optical fiber, comprising the following steps:
an optical fiber according to one of the preceding claims, and stripping means are provided; and
said optical fiber is brought into contact with said stripping means,
characterized in that it further includes a step (c) of causing a relative movement between the fiber and the stripping means.

15. Method according to claim 14, in which the stripping means provided at step (a) form an opening that can be adjusted substantially to the diameter of the fiber less twice the thickness of the coating of the fiber, and the contacting at step (b) also includes adjusting said opening to said reduced diameter.
